(19) United States
(12) Patent Application Publication
(10) Pub. No.: US 2024/0083710 A1
(43) Pub. Date: Mar. 14, 2024

(54) ROBOT INTERLOCKING ELEVATOR CONTROL SYSTEM

(71) Applicant: HYUNDAI ELEVATOR CO., LTD., Chungju-si (KR)

(72) Inventors: MoonSu KIM, Chungju-si (KR); DongHo KANG, Chungju-si (KR); SeungWoo LEE, Chungju-si (KR); DongHyun KWON, Chungju-si (KR)

(73) Assignee: HYUNDAI ELEVATOR CO., LTD., Chungju-si (KR)

(21) Appl. No.: 18/356,151

(22) Filed: Jul. 20, 2023

(30) Foreign Application Priority Data
Sep. 8, 2022 (KR) 10-2022-0113939
Sep. 8, 2022 (KR) 10-2022-0113940
Sep. 8, 2022 (KR) 10-2022-0113941
Sep. 14, 2022 (KR) 10-2022-0115412

(51) Int. Cl. B66B 1/34; B66B 1/46

(52) U.S. Cl. CPC B66B 1/3407; B66B 1/468; B66B 2201/214; B66B 2201/403

(57) ABSTRACT

Disclosed is a robot interlocking elevator control system for efficient control of elevators operated in association with robots autonomously moving in a building. The present disclosure provides a method of setting the most efficient elevator line to be exclusive for robots in consideration of traffic volume in the building, a method of assigning elevator lines and efficiently switching operation modes of elevators while suppressing an encounter between the robots and humans, and a method of setting robot boarding-related parameters for elevator lines set to allow use of the robots.

### CROSS-REFERENCE TO RELATED APPLICATION

This patent document claims priority to and the benefit of Korean Patent Application Nos. 10-2022-0113939, 10-2022-0113940 and 10-2022-0113941, filed on Sep. 8, 2022, and Korean Patent Application No. 10-2022-0115412, filed on Sep. 14, 2022, the entire disclosures of which are incorporated by reference for all purposes as if fully set forth herein.

### BACKGROUND

### Technical Field

The present disclosure relates to a robot interlocking elevator control system for efficient control of elevators operated in association with robots moving between floors in a building.

### Description of the Related Art

In various buildings constructed for residential, business, and commercial purposes, elevators are installed for smooth movement of passengers between floors in the buildings. Typically, the elevator includes an elevator car moving along a hoistway formed in a vertical direction inside a building, a mechanical part, which includes a motor for generating power for lifting or lowering the elevator car and a hoisting machine, a controller controlling operation of the elevator, and the like.

With recent activation of robot services in a building, there is an increasing need to use elevators to move robots between floors in the building. For example, various robots have been developed to carry out various tasks, such as transport, cleaning, and customer guidance while moving within a building.

Business in a building may require movement of robots between the floors. The elevators are considered the most desirable means for movement of robots between the floors and various interlocking control techniques between robots and an elevator system are being developed to achieve effective movement of robots to destination floors.

In recent years, with rapid growth of robot markets, various service areas are replaced by robots. In particular, the trend towards unmanned services using robots in customer service buildings, such as hotels and residences, is rapidly progressing. For expansion of functionality of the unmanned services using the robots, since vertical movement of the robots in the building (movement from floor to floor) is required, interlocking between the robots and the elevator system has become indispensable.

On the other hand, the use of an elevator by robots can inconvenience normal passengers (humans). For safety reasons or technical limitations, the robots can take a longer time to board or alight from an elevator car than normal passengers. For example, when a robot waits for an elevator service at a platform on a certain floor, a normal passenger on the same departure floor as the robot can experience a boarding delay due to the robot. In another example, a normal passenger having the same destination floor as a robot in the same elevator car can experience an alighting delay due to the robot.

As the robots take a long time to board or alight from the elevator, driving of the elevator can be delayed, causing increase in standby time of normal passengers waiting for the corresponding elevator at other floor platforms. For the same reason, a normal passenger having a different destination floor than a robot in the same elevator can be delayed in arriving at the destination floor. If there is a malfunction of the robot at the platform or inside the elevator, or if there is collision between the robot and a normal passenger, the problem of service delays described above can become more serious.

In order to address the above problem, an operation mode of each of multiple elevators installed in a building may be divided into a robot-exclusive mode, a passenger-exclusive mode, a share mode, in which robots and normal passengers use the corresponding elevator at the same time, and the like, according to the purpose or operation characteristics of the corresponding elevator.

An elevator set to the robot-exclusive mode allows a call service only for robots, an elevator set to the passenger-exclusive mode allows a call service only for normal passengers (humans), and an elevator set to the share mode allows a call service for both the robots and the normal passengers.

Here, since elevators set to different operation modes are used by different subjects, it is desirable that different operation characteristics also be applied to the elevators according to the operation modes. On the other hand, in application of general standards regardless of the operation modes, it is difficult to reflect the different operation characteristics according to the operation modes in control and operation of the elevators, causing disruptions in operation of the elevators in various situations and obstruction in efficient operation of the elevators.

### BRIEF SUMMARY

The present disclosure has been conceived to solve such problems in the art and it is one object of the present disclosure to provide a more convenient and comfortable service not only for normal passengers but also for customers using robot services in a building by providing a detailed operation method that can address disadvantages of each of operation modes including a robot-exclusive mode, a passenger-exclusive mode, and a share mode of an elevator system operated in association with robots.

It is another object of the present disclosure to provide a method of designating an efficient elevator line as a robot-exclusive elevator line in consideration of traffic in a building in response to a robot-exclusive mode setting request for some of multiple elevators installed in the building.

It is a further object of the present disclosure to provide a method for effective switching of operation modes in response to an operation mode switching request for a certain elevator line while reducing an encounter between a robot and a normal passenger and suppressing a service delay, in operation of each of elevator lines installed in a building and operated in various operation modes classified into a robot-exclusive mode, a passenger-exclusive mode, and a share mode.

It is yet another object of the present disclosure to provide a method of reducing an encounter between a robot and a normal passenger even in a share mode, in which an elevator can be simultaneously used by the robots and the normal passengers, by classifying the share mode into sub-modes and differentiating between statuses of the robots and the normal passengers in each of the sub-modes.

On the other hand, when a number of robots board a single elevator car of an elevator line set to a robot-exclusive mode, there can be an accident, such as collision between a normal passenger and a robot or collision between the robots, at a platform or inside the elevator car. In addition, a longer boarding/alighting time of the robots than that of the normal passengers can cause a service delay through increase in platform standby time and elevator boarding time of the normal passengers, thereby increasing passenger inconvenience due to deterioration in elevator traffic handling efficiency in a building.

It is yet another object of the present disclosure to provide a method of setting parameters (full rate, the maximum number of serviceable robots, and the like) related to boarding of robots with respect to an elevator line set to allow boarding of robots in order to provide more convenient and comfortable services to normal passengers and other passengers using robot services provided in a building while improving overall operation efficiency of an elevator system operated in association with the robots.

It will be understood that the present disclosure is not limited to the above object and other objects of the present disclosure will become apparent to those skilled in the art from the detailed description of embodiments.

In accordance with one aspect of the present disclosure, there is provided a robot interlocking elevator control system including: multiple elevators operated in association with robots autonomously moving in a building; and an elevator system controlling operation of the elevators installed in the building, wherein each of the multiple elevators is operated along an elevator line thereof in any one operation mode among a robot-exclusive mode allowing exclusive use of the robots, a passenger-exclusive mode preventing the robots from boarding the elevator, and a share mode allowing simultaneous boarding of the robots and normal passengers, and the elevator system includes a group management unit performing group management with respect to the multiple elevators, the group management unit calculating a traffic evaluation index with reference to call information preregistered to each of the elevator lines of the multiple elevators to set an elevator line having the lowest traffic to the robot-exclusive mode based on the traffic evaluation index upon setting at least one elevator line among the multiple elevators to the robot-exclusive mode, and delaying switching of the operation mode or immediately switching the operation mode in consideration of probability of an encounter between the robots and humans, in response to a request for switching of the operation mode of the elevator line.

The traffic evaluation index may include information on an average standby time indicating an average of estimated elapsed times from a certain point in time until completion of a service for each of call requests preregistered to each of the elevator lines, and information on a maximum standby time indicating an estimated elapsed time from a certain point in time until completion of services for all call requests preregistered to each of the elevator lines.

The group management unit may deduce a final evaluation value as a score based on the average standby time and the maximum standby time and may set an elevator line having the lowest final evaluation value to the robot-exclusive mode.

With respect to an elevator line set to the robot-exclusive mode among the multiple elevators, the group management unit may set the corresponding elevator line to be assigned to a robot call as soon as the corresponding elevator line is set to the robot-exclusive mode, or may sets the corresponding elevator line to be assigned to a robot call from a point in time at which a service for a call request of a normal passenger preregistered to the corresponding elevator line is completed.

When the corresponding elevator line is set to allow assignment to a robot call as soon as the corresponding elevator line is set to the robot-exclusive mode, the group management unit may cancel the call request of the normal passenger preregistered to the corresponding elevator line and may reassign an elevator of another elevator line in response to the call request of the normal passenger.

The group management unit may immediately switch the operation mode of the corresponding elevator line in response to a request for switching from another operation mode to the share mode, may delay switching of the operation mode of the corresponding elevator line until completion of services for calls of the normal passengers excluding a robot preregistered to the corresponding elevator line in response to the request for switching from another operation mode to the robot-exclusive mode, and may delay switching of the operation mode of the corresponding elevator line until completion of services for calls of the robots preregistered to the corresponding elevator line, in response to a request for switching from another operation mode to the passenger-exclusive mode.

The group management unit may immediately set the corresponding elevator line to be assigned to all of call requests of the robots and the normal passengers in response to a request for switching from another mode to the share mode.

The group management unit may set the corresponding elevator line to be assigned only to a call request of a robot after completion of all services for calls of the normal passengers preregistered to the corresponding elevator line, in response to a request for switching from another mode to the robot-exclusive mode.

The group management unit may exclude assignment of the corresponding elevator line with respect to a new call of a normal passenger in response to a request for switching from another mode to the robot-exclusive mode.

The group management unit may set the corresponding elevator line to be assigned only to a call of a normal passenger after completion of all services for call requests of the robots preregistered to the corresponding elevator line, in response to a request for switching from another mode to the passenger-exclusive mode.

The group management unit may exclude assignment of the corresponding elevator with respect to a new call of a robot in response to a request for switching from another mode to the passenger-exclusive mode.

The share mode may be divided into: a general share mode in which the robots and the humans are treated as equivalent objects with respect to calls from the robots and calls from the humans; a robot dominant share mode in which priority is given to the calls from the robots by applying an assignment suppression weight to the calls from the normal passengers; and a passenger dominant share mode, in which priority is given to the calls from the humans by applying the assignment suppression weight to the calls from the robots.

When an elevator line set to the general share mode is assigned to a robot call, the group management unit may temporarily switch the operation mode of the corresponding elevator line to the robot dominant share mode.

The group management unit may return the operation mode of the corresponding elevator line to the general share mode upon completion of a service for the robot call by the elevator line automatically switched to the robot dominant share mode.

When an elevator line set to the general share mode is assigned to a human call, the group management unit may temporarily switch the operation mode of the corresponding elevator line to the passenger dominant share mode.

The group management unit may return the corresponding elevator line to the general share mode upon completion of a service for the human call by the elevator line automatically switched to the passenger dominant share mode.

As such, for the elevator system operated in various operation modes including the robot-exclusive mode, the passenger-exclusive mode and the share mode, the present disclosure provides an operation method that can overcome disadvantages of each of the operation modes, thereby providing a more convenient and comfortable service not only for normal passengers but also for customers using robot services in a building. Accordingly, the present disclosure improves overall operation efficiency of the elevator system interlinked to the robots.

In addition, for the elevator system operated in various operation modes including the robot-exclusive mode, the passenger-exclusive mode and the share mode, the present disclosure suggests a method of setting parameters related to elevator boarding of robots by setting different full rates for robots and humans, restricting the maximum number of robots serviceable by an elevator line set to allow use by the robots, and the like.

According to the present disclosure, it is possible to reduce a service delay due to collision between robots and normal passengers or between the robots and to provide a more convenient and comfortable service not only for normal passengers but also for customers using robot services. Accordingly, the present disclosure can achieve remarkable improvement in overall operation efficiency of the robot interlinking elevator control system.

The present disclosure is not limited thereto and other effects of the present disclosure will become apparent from the following description.

### BRIEF DESCRIPTION OF THE SEVERAL VIEWS OF THE DRAWINGS

The above and other aspects, features, and advantages of the present disclosure will become apparent from the detailed description of the following embodiments in conjunction with the accompanying drawings:

FIG. 1 is a schematic block diagram of a robot interlocking elevator control system according to the present disclosure;

FIG. 2 is a flowchart illustrating a method of setting a full rate for each of operation modes of the robot interlocking elevator control system according to the present disclosure; and

FIG. 3 is a flowchart illustrating an elevator assignment method with respect to a robot call in the robot interlocking elevator control system according to the present disclosure.

### DETAILED DESCRIPTION

Hereinafter, exemplary embodiments of the present disclosure will be described in detail with reference to the accompanying drawings. It should be understood that the embodiments are provided for complete disclosure and thorough understanding of the present disclosure by those skilled in the art and that the present disclosure is not limited to the following embodiments and may be embodied in different ways by those skilled in the art.

The terminology used herein is for the purpose of describing particular embodiments and is not intended to be limiting. As used herein, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. Moreover, the singular forms, “a,” “an,” and “the” are intended to include the plural forms as well, unless the context clearly indicates otherwise.

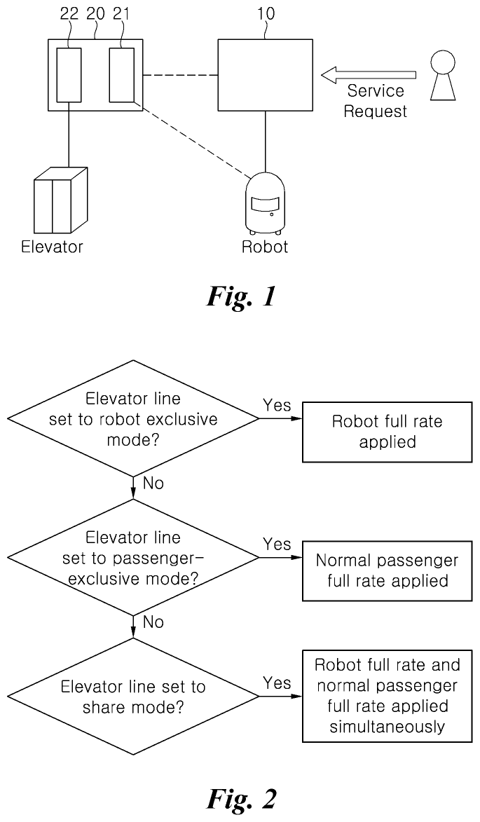

FIG. 1 is a schematic block diagram of a robot interlocking elevator control system according to the present disclosure.

Referring to FIG. 1, the robot interlocking elevator control system according to the present disclosure may include a robot system 10, which controls and manages robots autonomously moving in a building, and an elevator system 20, which controls and manages elevators installed in the building while communicating with the robots.

The robot system 10 and the elevator system 20 may be independently operated and may communicate with each other to allow use of the elevators when there is a need for movement of the robots between floors in the building.

The robot system 10 may control all of the robots autonomously moving in the building and may communicate with each of the robots for control of the robots. In addition, the robot system 10 may designate a particular robot providing a corresponding service in response to a robot service request generated in the building. Here, “robot service” may mean a service provided by a robot directly visiting a customer.

Herein, robots collectively refer to all kinds of autonomous mobile devices capable of autonomously moving without human manipulation in a building. By way of example, the robots may be service robots that carry out particular tasks, such as transport including parcel delivery, cleaning, and customer guidance, and the like, and may be controlled by the robot system 10 to provide services for customers in the building.

The robots may recognize a space within a building through a simultaneous localization and mapping (SLAM) method based on information collected using a Lidar, a short-distance sensor, an ultrasonic sensor, or a camera, and may move autonomously therein.

The robots may store information on an internal/external structure of the building and locations of elevators in the building through a database thereof, and may calculate an optimal distance and a movement route from a current location to an elevator calculated in real time based on the simultaneous localization and mapping method.

The robots may remotely call an elevator. In response to a robot service request from a customer in the building, the robot system 10 may designate a particular robot designed to provide the corresponding service among multiple robots operated in the building. When a current floor location of the designated robot is different from a service request floor, the designated robot may send a boarding request signal calling an elevator to the elevator system 20 in order to move to the service request floor.

Information included in the “boarding request” may include information on a departure floor corresponding to a current location of the robot and information on a destination floor to which the robot moves finally, and may further include information on a travel time for the robot to arrive at a platform, and information on the weight and volume of the robot, the purpose of using the elevator, and the like. The travel time for the robot to arrive at the platform may be calculated based on the current location of the robot.

In response to a remote call from a robot in the building, a group management unit 21 of the elevator system 20 described below may determine and assign an optimal elevator line that will provide a boarding service to the robot.

Herein, the elevator line means an identification number of a hoistway and a single elevator line may be provided with a single elevator car or multiple elevator cars.

The elevator system 20 may include: a group management unit 21 that performs group management with respect to multiple elevators installed in a building; and a controller 22 that controls operation of the elevators.

The group management unit 21 performs group control for more efficient operation of the multiple elevators installed in the building and may perform a function of determining and assigning optimal elevator lines in response to calls input through a call button fundamentally provided to each floor platform in the building, calls input through a destination floor input button disposed in each of elevator cars, remote calls input through another system or terminal, such as a destination selecting system (DSS), and remote calls from the robots.

Herein, a call instructing an elevator car of an elevator line, which is assigned to a call from a normal passenger or a robot at a platform in the building to move to a destination floor, to move to a standby floor on which the corresponding passenger or robot stands by is referred to as a hall call, and a call instructing the elevator car of the elevator line, which is arrived at the standby floor in response to the hall call, to move to the destination floor of the corresponding passenger or robot is referred to as a car call.

In addition, the group management unit 21 may determine and assign the most efficient elevator line in response to a call request of a robot in the building through correlation analysis with respect to a traffic volume, a plurality of available elevator lines and location information of the robot in the building. More specifically, the group management unit 21 may detect state information on the occupation rates or remaining capacity of multiple elevator lines operated in the building, may extract available elevator lines, which allow boarding of the robot, based on information, such as the weight of the robot, the volume of the robot, and the like, included in boarding request information received from the robot, and may assign an optimal elevator line in consideration of locations of the extracted available elevator lines and a location of the robot. Here, in consideration of the location of the robot, not only information on a location of a call floor (departure floor) where the robot requests elevator boarding but also information on a travel time of the robot from a current location to a platform may be taken into account.

The group management unit 21 may provide information on an assigned elevator line and information on the platform corresponding to the assigned elevator line to the robot requesting the call service and the robot system 10.

The controller 22 may control overall operation and behavior of the elevators and may control the elevator car in the elevator line assigned by the group management unit 21 to move to a call input floor.

The controller 22 may include a drive controller controlling driving of the elevator cars, and a door controller controlling opening/closing of elevator doors when the corresponding elevator cars stop at specific floors so as to allow normal passengers and robots to board or alight from the elevator cars.

The drive controller may control driving of the elevator cars to move upwards or downwards in a hoistway formed in the building in the vertical direction and may control a hoist motor and a brake to start or stop driving of the elevator cars.

The door controller may control overall opening/closing operation of the elevator doors including hall doors disposed at the platform and car doors provided to the elevator cars and may control driving of door motors.

The robot interlocking elevator control system according to the present disclosure may specify an operation mode of the elevators installed in the building into a robot-exclusive mode, a passenger-exclusive mode, and a robot/passenger share mode (hereinafter referred to as “share mode”).

The robot-exclusive mode refers to an operation mode set to allow only the robots to board the elevator car and an elevator set to the robot-exclusive mode may perform a call service only for the robots.

The passenger-exclusive mode refers to an operation mode set to allow only normal passengers to board the elevator car and an elevator set to the passenger-exclusive mode may perform a call service only for the normal passengers. Here, items, objects or animals belonging to the normal passengers may be carried thereby in the elevator car.

The share mode refers to an operation mode set to allow both robots and normal passengers (humans) to board the elevator car at the same time, and an elevator set to the share mode may perform a call service for both the robots and the normal passengers.

Multiple elevators installed in the built may be set to the operation modes according to the elevator lines thereof. The operation mode of each of the elevator lines may be automatically or manually set, as needed. For example, the operation mode of each of the elevator lines may be set corresponding to traffic characteristics in the building and the operation mode of a certain elevator line may be switched automatically through autonomous determination of the elevator system or manually by a manager when there is a need for switching of the operation mode through monitoring of the traffic in the building. In addition, the operation mode of each of the elevator lines may be previously set according to a time schedule corresponding to the traffic characteristics by time of day in the building.

For the elevator system having the operation mode classified into the robot-exclusive mode, the passenger-exclusive mode and the share mode, it is necessary to control the elevators in consideration of the characteristics of each operation mode in order to prevent inconvenience of normal passengers and service delays due to use of the elevators by the robots.

Hereinafter, an operation method capable of overcoming disadvantages of each of the operation modes including the robot-exclusive mode, the passenger-exclusive mode and the share mode for the elevator system operated in association with the robots will be described.

### 1. Robot-Exclusive Mode Setting

When some of the multiple elevators installed in the building are set to the robot-exclusive mode, the elevators, which are a limited share resource in the building, are set to be available only to the robots. This means a corresponding reduction in the number of elevators performing services for normal passengers (humans).

In addition, when a certain elevator line is arbitrarily extracted and designated as a robot-exclusive elevator line upon setting of the elevators in the building to the robot-exclusive mode, a platform standby time and an elevator boarding time of normal passengers are increased, thereby causing traffic jams in the building.

Accordingly, the present disclosure suggests a method of designating the most efficient elevator line as the robot-exclusive elevator line in consideration of traffic in the building when there is a need for setting an elevator line in the building to the robot-exclusive mode.

Specifically, the group management unit 21 of the elevator system 20 according to the present disclosure may conduct analysis of variables, such as traffic in the building, use frequency of each of the elevator lines, and the like, and may prioritize the least active elevator line based on an analysis result to set the least active elevator line to the robot-exclusive mode.

More specifically, the group management unit 21 may calculate traffic evaluation indexes of a corresponding elevator line, such as an average standby time, a maximum standby time, and the like, with reference to hall call/car call information preregistered to each of individual elevator lines of the multiple elevators in the building.

Here, “average standby time” may mean an average of estimated elapsed times from a certain point in time until completion of a service for each of hall calls and car calls preregistered to each of the elevator lines. In addition, “maximum standby time” may mean an estimated elapsed time from a certain point in time until completion of services for all of the hall calls and the car calls preregistered to each of the elevator lines, that is, the maximum estimated elapsed time among estimated elapsed times from a certain point in time until completion of services for each of the preregistered hall calls and car calls.

The group management unit 21 may deduce a final evaluation value with reference to the calculated traffic evaluation indexes of the individual elevator lines and designate an elevator line having the lowest evaluation value as the robot-exclusive elevator line. Here, the evaluation value may be a score calculated based on the average standby time and the maximum standby time and a lower evaluation value indicates an elevator line having a smaller traffic volume.

That is, according to the present disclosure, the elevator system may set the least active (idlest) elevator line to the robot-exclusive mode through monitoring of traffic in the building.

In addition, the group management unit 21 may consider a subject that has input a hall call/car call, that is, an input source, in calculation of the traffic evaluation index. This means that the traffic evaluation index may be calculated with respect to total traffic or passenger traffic based on values sought by a system manager and the robot-exclusive elevator line may be designated based on the calculation result.

For example, in order to designate an elevator line having the lowest total traffic as the robot-exclusive elevator line regardless of an input source (whether a call is requested by a robot or a person), the average standby time and the maximum standby time may be calculated with respect to all of hall calls/car calls generated and registered by robots and normal passengers in the building. In order to designate an elevator line having the lowest traffic of the normal passengers excluding the robots as the robot-exclusive elevator line, the average standby time and the maximum standby time may be calculated only with respect to hall calls/car calls generated by the normal passengers.

The group management unit 21 may recognize remaining calls excluding remote calls from the robots or calls input from the robot system 10 as the hall calls/car calls generated by the normal passengers.

The group management unit 21 may further include a calculation unit that calculates the traffic evaluation index and the evaluation value based on hall call/car call information preregistered to each of the elevator lines at a current point in time.

In addition, information on the traffic evaluation index and actual travel time calculated with reference to the hall call/car call information registered to the elevator lines may be stored and managed in a database. The calculation unit may perform machine learning with respect to data previously stored in the database and may establish a learning model for calculation of the traffic evaluation indexes including the average standby time and the maximum standby time based on hall call/car call information currently registered to each of the elevator lines.

Further, the calculation unit may determine traffic characteristics by time of day/day of week/each elevator line through machine learning of the previous data. The group management unit 21 may perform automatic scheduling of robot-exclusive mode setting for a certain elevator line based on information obtained through machine learning.

For example, meaningful data, such as the number of robots using the elevators in the building for certain hours in a day or on a certain day of the week, or the frequency of using a certain elevator line by the robots, and the like, may be accumulated through machine learning with respect to past data. The group management unit 21 may plan and establish robot-exclusive mode setting for the elevator lines based on the data.

Even in the case where setting of an elevator line in the building to the robot-exclusive mode is previously scheduled, the setting of the elevator line may be manually changed if an unusually different traffic volume is expected due to a particular event. For example, when a temporary increase in the number of visitors is expected due to an event, such as a conference or performance in the building, despite a preset schedule indicating that two elevator lines will be designated as the robot-exclusive elevator line for certain hours, control, for example, reduction in the number of elevator lines set to the robot-exclusive mode from two to one, may be performed.

That is, setting of the elevator lines in the building to the robot-exclusive mode may be automatically and/or manually performed.

On the other hand, when setting of a certain elevator line to the robot-exclusive mode is determined, the group management unit 21 may allow assignment of the corresponding elevator line to a robot call after completion of all services for preregistered hall calls/car calls of normal passengers (registered in a previous mode). Alternatively, the group management unit 21 may allow assignment of the corresponding elevator line to the robot call immediately after setting to the robot-exclusive mode. In the latter case, services may be carried out only for the robots by clearing (canceling or reassigning another elevator line to) the preregistered hall calls of the normal passengers.

This process prevents an encounter between robots and normal passengers boarding the elevator car of the corresponding elevator line or normal passengers (humans) scheduled to board the elevator car as much as possible in the course of switching to the robot-exclusive mode, and, upon switching of a certain elevator line to the robot-exclusive mode, a switching timing may be set through pre-optioning, which will be described in more detail in the following “switching between operation modes”.

### 2. Switching Between Operation Modes

The operation modes of the elevator lines in the building may be switched, as needed, or according to a preset time schedule, as described above.

In this case, in response to a request from the robot system 10, the group management unit 21 may switch the operation mode of the corresponding elevator from the robot-exclusive mode to the passenger-exclusive mode or the share mode, from the passenger-exclusive mode to the robot-exclusive mode or the share mode, or from the share mode to the robot-exclusive mode or the passenger-exclusive mode.

According to the present disclosure, each of the elevator operation modes is differently set according to subjects using the elevators. Thus, a subject using the corresponding elevator line may also be changed upon switching between the operation modes. If the elevator operation mode is switched without consideration of such change in using entities, traffic jams can occur due to increase in probability of an encounter between the robots and the normal passengers during switching between the operation modes.

TABLE 1

| Previous mode | Post-switching mode | Control logic |
|---|---|---|
| Robot-exclusive | Passenger-exclusive | Delay treatment |
| mode | mode | Exclusion of assignment to |
| | | new robot call |
| | Share mode | Immediate switching |
| Passenger- | Robot-exclusive mode | Delay treatment |
| exclusive mode | | Exclusion of assignment to |
| | | new normal passenger call |
| | Share mode | Immediate switching |
| Share mode | Robot-exclusive mode | Delay treatment |
| | | Exclusion of assignment to |
| | | new normal passenger call |
| | Passenger-exclusive | Delay treatment |
| | mode | Exclusion of assignment to |
| | | new robot call |

Table 1 shows control logics upon switching of the operation modes of the robot interlocking elevator control system according to the present disclosure.

Next, the control logics upon switching of the elevator operation modes in each case depending upon switching from a certain mode to another mode will be described in more detail with reference to Table 1.

(1) Case 1: Robot-Exclusive Mode→Passenger-Exclusive Mode

In response to a switching request for a certain elevator line from the robot-exclusive mode to the passenger-exclusive mode, in order to prevent an encounter between the robots and the normal passengers, the group management unit 21 may delay switching of the corresponding elevator line to the passenger-exclusive mode until all of hall calls/car call services for robots registered to the robot-exclusive mode (previous mode) are completed.

In addition, late switching to the passenger-exclusive mode can be suppressed by excluding assignment of the corresponding elevator line with respect to a new call request of a robot generated until actual switching to the passenger-exclusive mode is completed after occurrence of the switching request.

Since the elevator line is operated in the passenger-exclusive mode after completion of mode switching, assignment of the elevator line may be excluded with respect to the call request of the robot.

(2) Case 2: Robot-Exclusive Mode→Share Mode

In response to a switching request for a certain elevator line from the robot-exclusive mode to the share mode, the group management unit 21 may allow assignment of the corresponding elevator line to call requests of both the robots and the normal passengers by immediately switching the operation mode of the corresponding elevator line to the share mode.

(3) Case 3: Passenger-Exclusive Mode→Robot-Exclusive Mode

In response to a switching request for a certain elevator line from the passenger-exclusive mode to the robot-exclusive mode, in order to prevent an encounter between the robots and the normal passengers, the group management unit 21 may delay switching of the corresponding elevator line to the robot-exclusive mode until all of the hall call/car call services for the normal passengers registered to the passenger-exclusive mode (previous mode) are completed.

In addition, late switching to the robot-exclusive mode can be suppressed by excluding assignment of the corresponding elevator line with respect to a new call request of a normal passenger generated until actual switching to the robot-exclusive mode is completed after occurrence of the switching request.

Since the elevator line is operated in the robot-exclusive mode after completion of mode switching, assignment of the elevator line may be excluded with respect to the call request of the normal passenger.

(4) Case 4: Passenger-Exclusive Mode→Share Mode

In response to a switching request for a certain elevator line from the passenger-exclusive mode to the share mode, the group management unit 21 may allow assignment of the corresponding elevator line to call requests of both the robots and the normal passengers by immediately switching the operation mode of the corresponding elevator line to the share mode.

(5) Case 5: Share Mode→Robot-Exclusive Mode

In response to a switching request for a certain elevator line from the share mode to the robot-exclusive mode, in order to prevent an encounter between a robot, which will send a call request after switching of the operation mode, and a normal passenger under a call service or scheduled to receive a service, the group management unit 21 may delay switching of the corresponding elevator line to the robot-exclusive mode until all of the hall calls/car call services for the normal passengers registered to the share mode (previous mode) are completed.

In addition, late switching to the robot-exclusive mode can be suppressed by excluding assignment of the corresponding elevator line with respect to a new call request of a normal passenger generated until actual switching to the robot-exclusive mode is completed after occurrence of the switching request.

Since the elevator line is operated in the robot-exclusive mode after completion of mode switching, assignment of the elevator line may be excluded with respect to the call request of the normal passenger.

(6) Case 6: Share Mode→Passenger-Exclusive Mode

In response to a switching request for a certain elevator line from the share mode to the passenger-exclusive mode, there is a need to prevent an encounter between a normal passenger, who will send a call request after switching of the operation mode, and a robot under a call service or scheduled to receive a service. To this end, the group management unit 21 may delay switching of the corresponding elevator line to the passenger-exclusive mode until all of hall call/car call services for the robots registered to the share mode (previous mode) are completed.

In addition, late switching to the passenger-exclusive mode can be suppressed by excluding assignment of the corresponding elevator line with respect to a new call request of a robot generated until switching to the passenger-exclusive mode is completed after occurrence of the switching request.

Since the elevator line is operated in the passenger-exclusive mode after completion of mode switching, assignment of the elevator line may be excluded with respect to the call request of the robot.

In summary, upon switching of the operation modes of the elevator lines, the robot interlocking elevator system according to the present disclosure may delay or immediately perform switching of the operation mode depending upon which modes are to be switched between.

More specifically, upon switching to the share mode in which the elevator line can be simultaneously used by robots and normal passengers (humans), the robot interlocking elevator system according to the present disclosure may immediately switch the operation mode of the elevators without separate treatment. Conversely, when there is a probability of an encounter between the robots and the normal passengers (Cases 1, 3, 5, and 6) upon switching of the operation mode of the elevator line, the robot interlocking elevator system may delay switching of the operation mode. When the robot interlocking elevator system delays switching of the operation mode, the robot interlocking elevator system checks whether all of the registered hall calls/car calls are cleared in consideration of the input source and does not perform switching of the operation mode until all services are completed.

It should be understood that the present disclosure is not limited thereto and switching of the elevator line to an operation mode other than the share mode can be immediately performed. However, even in this case, in order to reduce an encounter between the robots and the normal passengers, a control of clearing (canceling or reassigning another elevator line) the existing hall calls may be performed.

Specifically, when switching from the passenger-exclusive mode or the share mode to the robot-exclusive mode is immediately performed, the preregistered hall calls of the normal passengers may be cleared and reassigned to another elevator line providing a service for the normal passengers.

Conversely, when switching from the robot-exclusive mode or the share mode to the passenger-exclusive mode is immediately performed, the preregistered hall calls of the robots may be cleared and reassigned to another elevator line providing a service for the robots.

In addition, determination as to whether switching of the operation modes of the elevators should be delayed or immediately performed may be set through pre-optioning.

### 3. Classification of Share Mode and Operation Methods Thereof

According to the present disclosure, the share mode allowing robots and normal passengers (humans) to simultaneously board the corresponding elevator car may be divided into three types of sub-modes and assignment of the elevator line under differentiation of statuses between the robots and the normal passengers may be performed with respect to a new call generated after registration of the robot call or the normal passenger call to the elevator line operated in the share mode. The present disclosure is aimed at providing a robot interlocking elevator system capable of reducing an encounter between the robots and the normal passengers in an elevator allowing simultaneous use of the robots and the normal passengers.

Specifically, according to the present disclosure, the share mode may be divided into three sub-modes, that is, a general share mode, a robot dominant share mode, and a passenger dominant share mode. Next, control logics for assignment of the elevator line according to each of these modes will be described in detail.

(1) General Share Mode

In the general share mode, the robots and the normal passengers are treated as equivalent objects. That is, the robots and the normal passengers (humans) have the same status and assignment may be made without differentiating calls by robots from calls by normal passengers. However, it should be noted that this means that there will be no differentiation in allocation to the robots and the normal passengers and does not mean that the full rate for robots and the full rate for normal passengers must be set to the same value. As such, the full rates with respect to the robots and the normal passengers may be set to different values.

(2) Robot Dominant Share Mode

Although an elevator line set to the robot dominant share mode may provide a service for both the robots and the normal passengers, an assignment suppression weight may be applied to normal passenger calls when the elevator line provides a service for robot calls.

That is, the robot dominant share mode refers to a mode in which the status of the robots is set to be higher than the status of the normal passengers, and allows assignment suppression with respect to the normal passenger calls to allow a service for the robot calls while avoiding a service for the normal passenger calls as much as possible.

Here, assignment suppression does not mean 100% exclusion of new calls. Rather, when performing an allocation algorithm for a new call, assignment suppression means that the corresponding elevator line is not assigned to the new call as much as possible by lowering priority of the new call, for example, by applying an “allocation suppression weight” to the corresponding elevator line (hereinafter the same).

With respect to the normal passenger calls, the group management unit 21 may apply the “allocation suppression weight” to the elevator line, which is operated in the robot dominant share mode and to which a hall call or a car call is registered by a robot call. As a result, share of the corresponding elevator car by the robots and the normal passengers can be prevented until all of call services for the robots are completed (until a car call service for the latest boarding robot is completed).

In addition, the “allocation suppression weight” may not be applied to call services for the normal passengers after all of the call services for the robots are completed. That is, when a robot call is registered to a certain elevator line operated in the general share mode, the corresponding elevator line may be temporarily set to the robot dominant share mode and may then be returned to the general share mode after all of the hall call/car call services for the robots are completed.

(3) Passenger Dominant Share Mode

In the passenger dominant share mode, control is carried out in an opposite manner to the robot dominant share mode. Although an elevator line set to the robot dominant share mode can provide a service for both the robots and the normal passengers, an assignment suppression weight may be applied to robot calls when the elevator line provides a service for passenger calls.

That is, the passenger dominant share mode refers to a mode in which the status of the normal passengers is set to be higher than the status of the robots, and allows assignment suppression with respect to the robot calls to allow a service for the normal passenger calls while avoiding a service for the robot calls as much as possible.

With respect to the robot calls, the group management unit 21 may apply the “allocation suppression weight” to the elevator line, which is operated in the passenger dominant share mode and to which a hall call or a car call is registered by a normal passenger call. As a result, share of the corresponding elevator car by the robots and the normal passengers may be prevented until all of call services for the normal passengers are completed (until a car call service for the latest boarding passenger is completed).

The “allocation suppression weight” may not be applied to call services for the robots after all of the call services for the normal passengers are completed. That is, when a normal passenger call is registered to a certain elevator line operated in the general share mode, the corresponding elevator line may be temporarily set to the passenger dominant share mode and may then be returned to the general share mode after all of the hall call/car call services for the normal passengers are completed.

Whether to or not to apply such an allocation suppression weight may be optioned by pre-setting.

### 4. Robot-Related Parameter Setting

The elevators operated in various operation modes classified into the robot-exclusive mode, the passenger-exclusive mode, and the share mode may have different operation characteristics due to different subjects using the elevators in each operation mode.

In operation of the multiple elevators installed in the building by setting each of the elevator lines to any one of the robot-exclusive mode, the passenger-exclusive mode and the share mode, the present disclosure suggests a method of setting robot boarding-related parameters of the elevator lines such that different characteristics of the robots and the normal passengers (humans) can be applied to operation of the elevators in each of the operation modes, as follows.

(1) Full Rate Setting

FIG. 2 is a flowchart illustrating a method of setting a full rate for each of operation modes of the robot interlocking elevator control system according to the present disclosure.

Referring to FIG. 2, first, the robot interlocking elevator control system according to the present disclosure may differently set the full rate for robots and the full rate for normal passengers (humans). This feature is based on the fact that a single robot generally occupies a larger space and has a heavier weight than an individual normal passenger. By setting a lower full rate reference for robots than for normal passengers, a space available for the normal passengers can be differentiated from a space available for the robots.

The robot interlocking elevator control system according to the present disclosure may set a lower full rate for robots than for normal passengers in consideration of the weight, volume, radius action, and safety distance of the robots. Here, the full rate may be determined based on a load or a space occupation rate and will be described below in more detail. The full rate reference for robots and the full rate reference for normal passengers may be changed according to specifications of the robots or each of the elevator lines.

That is, the present disclosure may apply a “robot full rate” and a “normal passenger full rate” depending on which mode each of the elevator lines installed in the building is operated in. The following description will focus on reference for application of the full rate according to the operation modes of the elevators.

First, since the use of an elevator line set to the robot-exclusive mode is exclusively allowed for the robots, the elevator line may be operated at the “robot full rate.” The elevator line set to the robot-exclusive mode may become an assignment object for robot calls with reference to the robot full rate. For example, in application of a robot full rate of 60%, allocation of an elevator line having a load or space occupation rate of greater than 60% by the robots on the elevator car of the elevator line may be suppressed or excluded with respect to a new call of a robot. In addition, since the corresponding elevator line is operated under the robot-exclusive mode, allocation of the corresponding elevator line may be excluded with respect to calls of the normal passengers.

Since the use of an elevator line set to the passenger-exclusive mode is exclusively allowed for normal passengers (humans), the elevator line may be operated at the “normal passenger full rate.” The elevator line set to the passenger-exclusive mode may become an assignment object for normal passenger calls with reference to the normal passenger full rate. For example, in application of a normal passenger full rate of 80%, allocation of an elevator line having a load or space occupation rate of greater than 80% by the normal passengers on the elevator car of the elevator line may be suppressed or excluded with respect to a new call of a normal passenger. In addition, since the corresponding elevator line is operated under the passenger-exclusive mode, allocation of the corresponding elevator line may be excluded with respect to calls of the robots.

Lastly, since an elevator line set to the share mode provides a service for both the robots and the normal passengers (humans), the elevator line may be operated at the “robot full rate” and at the “normal passenger full rate.” The elevator line set to the share mode may become an assignment object for the robot calls with reference to the robot full rate and an assignment object for the normal passenger calls with reference to the normal passenger full rate.

In addition, according to the present disclosure, the “full rate” of the elevators may include a concept of “load full rate” with reference to load (weight) and a concept of “space full rate” with reference to an occupied space area. The load full rate is a value to limit the total load of objects boarding the elevator car of the elevator line so as not to exceed a certain level and the space full rate is a value to limit the total space area occupied by the objects in the elevator car of the elevator line so as not to exceed a certain level.

Information on the loads of the objects in the elevator car of the elevator line may be detected by a load cell provided to the elevator car and information on the space area occupied by the objects in the elevator car of the elevator line may be detected by a vision device, such as a camera or a CCTV, provided to the elevator car.

For example, assuming that the load full rate of the elevator line is set to 60%, when a boarding load (the sum of weights of boarding objects), as measured in real time by the load cell, is detected to be greater than 60% of the rated capacity (maximum design load), the corresponding elevator line may be switched to a full state and assignment of the corresponding elevator line may be suppressed or excluded with respect to a new call while limiting new boarding with respect to the corresponding elevator line until the boarding load of the corresponding elevator line is returned to 60% or less.

Similarly, assuming that the space full rate of the elevator line is set to 60%, when a space occupation area (the area occupied by the boarding objects), as measured by the vision device, is detected to be greater than 60% of the total inner area of the corresponding elevator line, the corresponding elevator line may be switched to a full state. In addition, assignment of the corresponding elevator line may be suppressed or excluded with respect to a new call while limiting new boarding with respect to the corresponding elevator line until the interior occupation rate of the corresponding elevator line is returned to 60% or less.

The “load full rate” and the “space full rate” may be applied selectively or simultaneously. If the load full rate and the space full rate are applied simultaneously, the corresponding elevator line may be switched to a full state when the corresponding elevator line exceeds any one of the load full rate and the space full rate.

Hereinafter, the full rate setting of the robot interlocking elevator control system according to the present disclosure will be described with reference to some embodiments.

First, assume that the elevator system includes five elevator lines installed in a building and performs group control. Here, assuming that, among elevator lines Nos. 1 to 5, elevator lines No. 2 and No. 5 are set to a share mode in which a service can be carried out with respect to robot calls and normal passenger calls. In addition, the robot full rate is set to 60% and the normal passenger full rate is set to 80%.

In operation of the elevators, when the total load of boarding objects (including all of the robots and the normal passengers) in an elevator car of elevator line No. 2 is 70%, the corresponding elevator line still has a remaining capacity of 10% in terms of the full rate for normal passengers, but exceeds the full rate for robots. In this case, the group management unit 21 may allow assignment of elevator line No. 2 with respect to normal passenger calls while excluding assignment of elevator line No. 2 with respect to robot calls. Since elevator line No. 2 is still able to provide a service with respect to the normal passenger calls, full bypass is not applied thereto. In addition, with respect to a new robot call, an elevator line having the highest service efficiency among elevator lines Nos. 1 to 5 excluding elevator line No. 2 may be selected and assigned.

That is, when a certain elevator line is full with reference to the robot full rate and is not full with reference to the normal passenger full rate, the corresponding elevator line is neither assigned for robot calls nor allows application of full bypass thereto.

On the other hand, when the total load (boarding load) in the elevator car of elevator line No. 4 is 81%, the corresponding elevator line exceeds both the full rate for robots and the full rate for normal passengers. Accordingly, the corresponding elevator line No. 4 bypasses a hall call (platform call) preassigned in a traveling direction thereof. In this state, when a new call is generated, an elevator line having the highest service efficiency among the other elevator lines excluding elevator line No. 4 and not exceeding the full rate of subjects (robots or normal passengers) that have input the corresponding call may be selected and assigned. Here, another elevator line may be optionally assigned to the hall call bypassed by elevator line No. 4.

When a certain elevator line is full with reference to the normal passenger full rate (in this case, the elevator line is also full with reference to the robot full rate), full bypass is applied to the corresponding elevator line. In application of full bypass, assignment of the corresponding elevator line may be suppressed or excluded.

As such, according to the present disclosure, by differentiating the full detection reference for the robots and the normal passengers, application of full bypass to the normal passengers can be relieved without deterioration in service efficiency.

(2) Limitation of the Number of Serviceable Robots

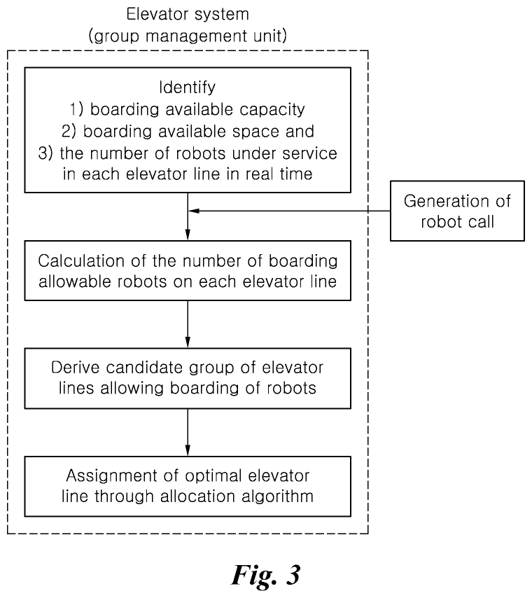

FIG. 3 is a flowchart illustrating an elevator assignment method with respect to a robot call in the robot interlocking elevator control system according to the present disclosure.

Referring to FIG. 3, the present disclosure can suppress collision between robots and normal passengers or between the robots using the elevators without deterioration in efficiency of handling traffic of the elevators in the building and a service delay by limiting the number of serviceable robots for a single elevator.

Specifically, the present disclosure may set the maximum number of serviceable robots for a single elevator in consideration of a traffic pattern detected manually or automatically.

The maximum number of serviceable robots may be set by the group management unit 21 in response to a request of the robot system 10 or may be autonomously set by the group management unit 21. Here, the maximum number of serviceable robots may be differently set according to the above operation modes of the elevators.

In addition, the robot interlocking elevator control system according to the present disclosure provides the robot-exclusive mode and the share mode as the operation modes in which the robots can use the elevators. Here, the number of serviceable robots in the robot-exclusive mode may be set to be greater than that in the share mode. That is, an elevator line set to the robot-exclusive mode may accommodate a greater number of robots than an elevator line set to the share line.

As such, with the maximum number of serviceable robots set for each of the elevator lines of the multiple elevators in the building, the group management unit 21 may calculate a boarding available capacity, a boarding available space and the number of serviceable robots on each floor in a traveling route of the corresponding elevator line through real-time collection and analysis of information on elevator specifications, such as a rated capacity and an interior area, a load full rate and/or a space full rate for normal passengers according to each traffic pattern manually or automatically detected, a load full rate and/or a space full rate for robots according to each traffic pattern manually or automatically detected, hall call/car calls preregistered to each elevator line, the number of robots and/or normal passengers in an elevator car of each elevator line, the number of robots and/or normal passengers scheduled to board an elevator car of each elevator line in a traveling direction of the elevator car, specifications (volume, weight, and the like) of robots boarding an elevator car of each elevator line or scheduled to board the elevator car, and the like.

Here, “boarding available capacity” means a load that can be additionally carried by the elevator car of the elevator line and “boarding available space” means the area of a space that can be additionally occupied in the elevator line. In addition, “number of serviceable robots” means the number of robots to which the elevator line currently provides a hall call/car call service and may be calculated by including not only the number of robots on the corresponding elevator line but also the number of robots waiting at a platform.

Further, “according to each traffic pattern” means that the full rate of the elevator line may be differently set according to the traffic pattern even in the same operation mode. For example, different traffic patterns at different times of day in the building may be reflected in setting the full rate of the elevators in the building.

More specifically, the passenger traffic in the elevators can vary by time of day during special events, such as rush hour, off-hour, and lunch. The traffic volume can also vary in a traveling direction, with more traffic in an upward direction during rush hour and more traffic in a downward direction during off-hour. The present disclosure enables flexible operation of the multiple elevators installed in the building by identifying and retaining information on the traffic patterns by time of day and in the traveling direction in advance and setting different full rates not only for robots and normal passengers as described above, but also according to different traffic patterns.

As such, the group management unit 21 according to the present disclosure may calculate and identify the boarding available capacity, the boarding available space and the number of serviceable robots on each floor in real time in the traveling route of each of the elevator lines operated in the building based on various pieces of information.

Then, in response to a call request from a robot in the building, the group management unit 21 may organize a primarily assignable candidate group of elevator lines by selecting elevator lines coincident with all specifications of the robot in terms of the boarding available capacity and the boarding available space among elevator lines set to the robot-exclusive mode or the share mode and capable of providing a service to a departure floor and a destination floor of the corresponding robot. That is, the group management unit 21 extracts the candidate group of elevator lines capable of accommodating the robot among the multiple elevators installed in the building in consideration of the specifications of the robot.

In addition, the group management unit 21 may reorganize a candidate group of assignable elevator lines by selecting elevator lines, in which an anticipated number of serviceable robots on a floor immediately preceding the departure floor of the robot having requested the current call in a traveling direction of the robot towards the destination floor where the robot wants to arrive does not exceed the maximum number of serviceable robots set to each of the elevator lines, among the primary candidate group of elevator lines. Here, since robot calls are remotely provided through the system unlike normal passenger calls and are less likely to be generated unexpectedly, it is possible to predict the number of robots in service on the floor immediately preceding the departure floor of the robot having requested the call.

The group management unit 21 may determine the most efficient elevator line among the reorganized assignable candidate group of elevator lines through an assignment algorithm previously established therein to assign the determined elevator line to the robot that has requested the call.

The group management unit 21 may calculate the number of available robots on each floor and in each direction on the traveling route of the robots based on current status information. The group management unit 21 may exclude the corresponding elevator line with respect to a new call on a floor on which the number of available robots is 0.

As such, the robot interlocking elevator control system according to the present disclosure may set the maximum number of serviceable robots for each of the elevator lines of the multiple elevators installed in the building, may determine the boarding available capacity, the boarding available space and the number of serviceable robots of each of the elevator lines operated in the building, and may perform assignment of the elevators with respect to robot calls based on such information. As a result, the robot interlocking elevator control system according to the present disclosure may provide effective robot interlocking elevator services while flexibly responding to traffic patterns in the building without inconvenience of the normal passengers.

Further, the robot interlocking elevator control system according to the present disclosure extracts a primary candidate group of elevator lines coincident with specifications of the robots and then performs an assignment algorithm with respect to elevator lines, which have the number of serviceable robots not exceeding the maximum number of serviceable robots set to each of the elevator lines, among the primary candidate group of elevator lines, thereby advantageously providing elevator services with respect to various types of robots having different specifications without interruption.

On the other hand, when the total number of robots under current service is equal to or greater than a preset reference in an elevator line available to robots (that is, an elevator line set to the robot-exclusive mode and the share mode), assignment of the corresponding elevator line may be excluded with respect to a new robot call. Here, ‘under current service’ include all cases where hall call/car call services are provided in response to robot calls. That is, it should be interpreted not only as the case where the robots board the corresponding elevator line but also the case where the robots wait for the assigned elevator line at the platform.

In addition, when the corresponding elevator line completes a car call service of at least one floor in response to the robot call or a request for a hall call service of at least one floor is canceled, the corresponding elevator line may be set to allow assignment with respect to a new robot call.

That is, the number of robots under current service in a single elevator line is detected and, when it is determined that the number of robots under hall call/car call services is greater than or equal to a preset number of robots, assignment of the corresponding elevator line may be excluded with respect to a new robot call.

In addition, when the same call floor and/or destination floor is input by calls of 2 or more robots, the number of robots allocated to the same elevator line is limited to a predetermined number of robots or less and the robots may be distributed to multiple elevator lines. Here, assignment of the elevator lines may be made by prioritizing the elevator lines with lower robot occupation rates in consideration of the robot occupation rate of each of the elevator lines assignable with respect to robot calls.

The robot interlocking elevator control system according to the present disclosure described above may include at least one processor implemented to execute computer-readable instructions. Further, the present disclosure may be implemented as computer-readable code on a computer-readable recording medium. The computer-readable recording medium may include all kinds of recording media storing data that can be read by a computer system, for example, ROM, RAM, CD-ROM, a magnetic tape, a floppy disk, an optimal data storage device, and the like.

Although some exemplary embodiments have been described herein, it should be understood that these embodiments are given by way of illustration only and that various modifications, variations, and alterations can be made by those skilled in the art without departing from the spirit and scope of the present disclosure. Therefore, the scope of the disclosure should be limited only by the appended claims and equivalents thereto.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A robot interlocking elevator control system comprising:
multiple elevators operated in association with robots autonomously moving in a building; and
an elevator system controlling operation of the elevators installed in the building,
wherein each of the multiple elevators is operated along an elevator line thereof in any one operation mode among a robot-exclusive mode allowing exclusive use of the robots, a passenger-exclusive mode preventing the robots from boarding the elevator, and a share mode allowing simultaneous boarding of the robots and normal passengers, and
the elevator system comprises a group management unit performing group management with respect to the multiple elevators,
the group management unit calculating a traffic evaluation index with reference to call information preregistered to each of the elevator lines of the multiple elevators to set an elevator line having the lowest traffic to the robot-exclusive mode based on the traffic evaluation index upon setting at least one elevator line among the multiple elevators to the robot-exclusive mode, and delaying switching of the operation mode or immediately switching the operation mode in consideration of probability of an encounter between the robots and humans in response to a request for switching of the operation mode of the elevator line.

2. The robot interlocking elevator control system according to claim 1, wherein the traffic evaluation index comprises information on an average standby time indicating an average of estimated elapsed times from a certain point in time until completion of a service for each of call requests preregistered to each of the elevator lines, and information on a maximum standby time indicating an estimated elapsed time from a certain point in time until completion of services for all call requests preregistered to each of the elevator lines.

3. The robot interlocking elevator control system according to claim 2, wherein the group management unit deduces a final evaluation value as a score based on the average standby time and the maximum standby time and sets an elevator line having the lowest final evaluation value to the robot-exclusive mode.

4. The robot interlocking elevator control system according to claim 1, wherein, with respect to an elevator line set to the robot-exclusive mode among the multiple elevators, the group management unit sets the corresponding elevator line to be assigned to a robot call as soon as the corresponding elevator line is set to the robot-exclusive mode, or sets the corresponding elevator line to be assigned to the robot call from a point in time at which a service for a call request of a normal passenger preregistered to the corresponding elevator line is completed.

5. The robot interlocking elevator control system according to claim 4, wherein, when the corresponding elevator line is set to allow assignment to a robot call as soon as the corresponding elevator line is set to the robot-exclusive mode, the group management unit cancels the call request of the normal passenger preregistered to the corresponding elevator line and reassigns an elevator of another elevator line in response to the call request of the normal passenger.

6. The robot interlocking elevator control system according to claim 1, wherein the group management unit immediately switches the operation mode of the corresponding elevator line in response to a request for switching from another operation mode to the share mode, delays switching of the operation mode of the corresponding elevator line until completion of services for calls of the normal passengers excluding a robot preregistered to the corresponding elevator line, in response to a request for switching from another mode to the robot-exclusive mode, and delays switching of the operation mode of the corresponding elevator line until completion of services for calls of the robots preregistered to the corresponding elevator line, in response to a request for switching from another operation mode to the passenger-exclusive mode.

7. The robot interlocking elevator control system according to claim 6, wherein the group management unit immediately sets the corresponding elevator line to be assigned to all of call requests of the robots and the normal passengers in response to a request for switching from another mode to the share mode.

8. The robot interlocking elevator control system according to claim 6, wherein the group management unit sets the corresponding elevator line to be assigned only to a call request of a robot after completion of all services for calls of the normal passengers preregistered to the corresponding elevator line, in response to a request for switching from another mode to the robot-exclusive mode.

9. The robot interlocking elevator control system according to claim 6, wherein the group management unit excludes assignment of the corresponding elevator line with respect to a new call of a normal passenger in response to a request for switching from another mode to the robot-exclusive mode.

10. The robot interlocking elevator control system according to claim 6, wherein the group management unit sets the corresponding elevator line to be assigned only to a call of a normal passenger after completion of all services for call requests of the robots preregistered to the corresponding elevator line, in response to a request for switching from another mode to the passenger-exclusive mode.

11. The robot interlocking elevator control system according to claim 6, wherein the group management unit excludes assignment of the corresponding elevator with respect to a new call of a robot in response to a request for switching from another mode to the passenger-exclusive mode.

12. The robot interlocking elevator control system according to claim 1, wherein the share mode is divided into:
a general share mode in which the robots and the humans are treated as equivalent objects with respect to calls from the robots and calls from the humans;
a robot dominant share mode in which priority is given to the calls from the robots by applying an assignment suppression weight to the calls from the normal passengers; and
a passenger dominant share mode, in which priority is given to the calls from the humans by applying the assignment suppression weight to the calls from the robots.

13. The robot interlocking elevator control system according to claim 12, wherein, when an elevator line set to the general share mode is assigned to a robot call, the group management unit temporarily switches the operation mode of the corresponding elevator line to the robot dominant share mode.

14. The robot interlocking elevator control system according to claim 13, wherein the group management unit returns the operation mode of the corresponding elevator line to the general share mode upon completion of a service for the robot call by to the elevator line automatically switched to the robot dominant share mode.

15. The robot interlocking elevator control system according to claim 12, wherein, when an elevator line set to the general share mode is assigned to a human call, the group management unit temporarily switches the operation mode of the corresponding elevator line to the passenger dominant share mode.

16. The robot interlocking elevator control system according to claim 15, wherein the group management unit returns the operation mode of the corresponding elevator line to the general share mode upon completion of a service for the human call by the elevator line automatically switched to the passenger dominant share mode.
